(19) United States
(12) Patent Application Publication
(10) Pub. No.: US 2026/0075285 A1
(43) Pub. Date: Mar. 12, 2026

(54) ELECTRONIC MEDIA DEVICE RESET TECHNIQUES

(71) Applicant: Roku, Inc., San Jose, CA (US)

(72) Inventors: Joel Anthony East, Austin, TX (US); Gregory Mack Garner, Key Colony Beach, FL (US); David Lee Stern, Los Gatos, CA (US); Mikkel Nielsen, San Jose, CA (US); Gregory Hogan, Fresno, CA (US)

(73) Assignee: Roku, Inc., San Jose, CA (US)

(21) Appl. No.: 19/008,830

(22) Filed: Jan. 3, 2025

Related U.S. Application Data
(60) Provisional application No. 63/693,318, filed on Sep. 11, 2024.

(51) Int. Cl. H04N 21/443; H04N 21/4363

(52) U.S. Cl. CPC H04N 21/443; H04N 21/43635

(57) ABSTRACT

An apparatus is described and includes a portable media streaming device including an assembly that includes a USB-C port; and a switch integrated with the USB-C port, the switch generating a signal when the switch is actuated, the signal for triggering a factory reset of the portable media streaming device.

### CROSS-REFERENCE TO RELATED APPLICATION

This application claims the benefit of and priority to U.S. Patent Application Ser. No. 63/693,318, filed Sep. 11, 2024, entitled “ELECTRONIC MEDIA DEVICE RESET TECHNIQUES,” which is incorporated herein by reference in its entirety.

### TECHNICAL FIELD

This disclosure relates generally to electronic media devices, such as televisions (TVs) and streaming devices, and more specifically, to techniques and arrangements for enabling a user to initiate factory reset of such devices.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1A and 1B illustrate perspective views of opposing sides of an example streaming device comprising a portable streaming stick in which some embodiments of the disclosure may be implemented.

FIG. 2 illustrates an example printed circuit board of the example streaming device shown in FIGS. 1A and 1B.

FIGS. 3A and 3B illustrate top and side plan views of an example streaming device comprising a portable streaming stick including a combination reset button and USB-C connector assembly according to some embodiments of the disclosure.

FIG. 3C illustrates a representation of the combination reset button and USB-C connector assembly implemented in the portable streaming stick shown in FIGS. 3A and 3B according to some embodiments of the disclosure.

FIG. 4 is a high-level block diagram of an example smart TV system according to some embodiments of the disclosure.

FIG. 5A illustrates connection of an HDMI cable to HDMI ports of a smart TV system, such as the example smart TV system shown in FIG. 4, according to some embodiments of the disclosure.

FIG. 5B illustrates example circuitry for enabling an HDMI loopback device reset technique according to some embodiments of the disclosure.

FIG. 6 illustrates a flow chart of example operations for a method of performing an HDMI loopback reset of an electronic media device according to some embodiments of the disclosure.

FIG. 7 illustrates a flow chart of example operations for another method of performing an HDMI loopback reset of an electronic media device according to some embodiments of the disclosure.

FIG. 8 illustrates a block diagram of an exemplary computing device, according to some embodiments of the disclosure.

### DETAILED DESCRIPTION

### Overview

A factory reset is a software reset of an electronic device, such as a television or a streaming device, that restores the device to its original system state by erasing all data, settings, and applications stored on the device by a user. A factory reset may be performed to address a chronic performance issue being experienced by the device, such as “freezing.” Additionally and/or alternatively, a factory reset may be performed to prepare a device for sale, refurbishment, disposal, or other transfer of ownership by removing personal data and/or settings associated with a previous user. A factory reset does not remove or affect the operating system of the device.

Factory resets may be initiated in a variety of ways, depending on the type of electronic device. For example, devices with displays, such as TVs, may provide a menu option that may be selected to initiate a factory reset. In situations where the screen is not working or the device does not have a screen (as is the case with many USB stick streaming devices), an additional/alternative mechanism may be provided. For example, a physical reset button may be provided on an external surface of the device, actuation of which by a user causes a factory reset of the device to be performed.

In some devices, a physical reset button may be implemented as a tactile button that a user can depress with his or her finger. Alternatively, a physical reset button may be implemented as a pinhole button that may be actuated using a straightened paperclip or similar mechanism. In particular embodiments, a factory reset is initiated by a user's powering on the device and then pressing and holding the reset button for a first designated length of time (e.g., approximately 10 seconds). An indicator light or status light emitting diode (LED) may be provided on the device for indicating when factory reset has been started and/or completed e.g., by emitting light of particular color or by blinking in a predetermined pattern or at a predetermined rate).

In addition to a factory reset, electronic devices may provide a recovery mode during which the device's operating system may be reinstalled over the Internet or from a USB flash drive. To place the device in recovery mode, the user may be required to power on the device and then press and hold the reset button for a second designated length of time (typically longer than the first designated length of time (e.g., approximately 20 seconds)).

For a variety of reasons involving one or more of cost, device size, and printed circuit board (PCB) space, there is a desire among electronic media device manufacturers to omit dedicated physical reset buttons on such devices. In order to accomplish that goal, alternative means of initiating factory reset (and possibly restore mode) for electronic devices that lack a functioning display are desirable.

### Example Streaming Device With Dedicated Reset Button

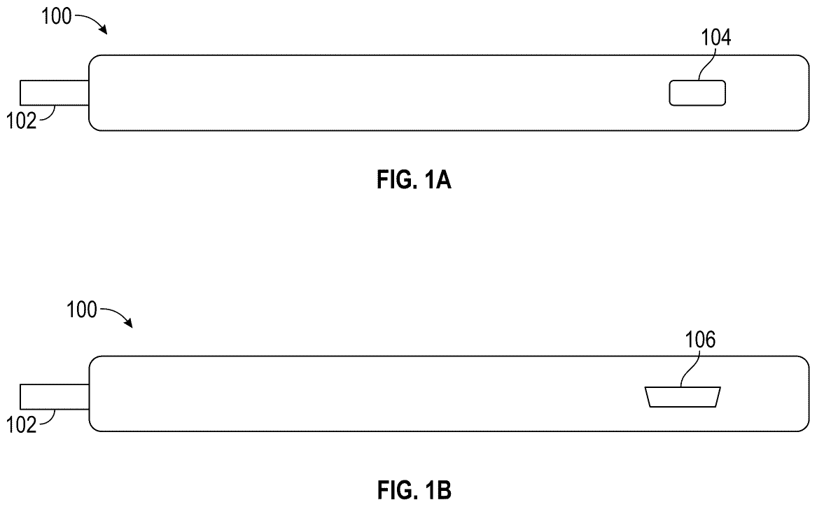

FIGS. 1A and 1B illustrate perspective views of opposing sides of an example streaming device comprising a portable streaming stick 100 in which some embodiments of the disclosure may be implemented. Streaming stick 100 includes a male USB connector 102 that may be connected into any TV that provides a corresponding female USB port. Streaming stick 100 includes hardware and software to enable a basic TV to function as a smart (or streaming) TV. Streaming stick 100 connects to the internet and allows media to be accessed from a specific streaming service with which the stick 100 is associated.

Although for the sake of simplicity, embodiments may be described herein with reference to a streaming stick, such as streaming stick 100, it will be recognized that such embodiments are equally applicable to other types of streaming devices, including streaming boxes and other types of portable digital media players designed to be connected to a television and/or AV receiver for enabling consumption of content from streaming media services, including subscription-based over-the-top content services. Such devices typically have a compact form factor, such as a set-top box, dongle, or stick.

In an example conventional configuration, streaming stick 100 may include a tactile reset button 104 for enabling factory reset and/or recovery mode of the stick on one side thereof (FIG. 1A) and a USB-C port 106 for enabling charging of the stick on the opposite side thereof (FIG. 1B).

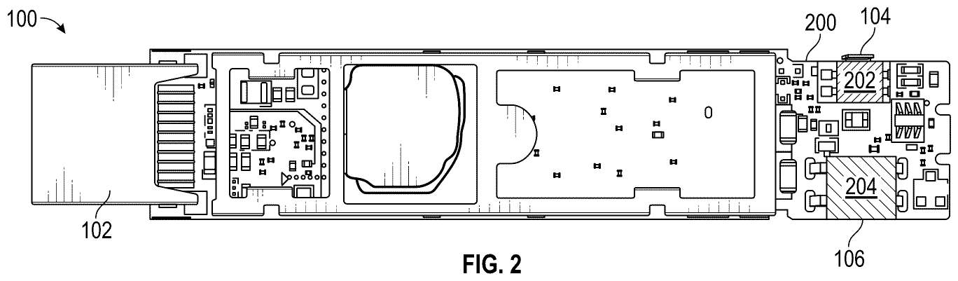

Referring now to FIG. 2, illustrated therein is an example printed circuit board (PCB) 200 of the streaming stick 100. Area 202 represents a footprint of the hardware and circuitry on PCB 200 associated with (and/or necessitated by) reset button 104. Similarly, area 204 represents a footprint of the hardware and circuitry on PCB 200 associated with (and/or necessitated by) USB-C port 106. As clear from FIG. 2, including a dedicated reset button, such as button 104, on a streaming device, such as streaming stick 100, takes up valuable real estate on the device's PCB.

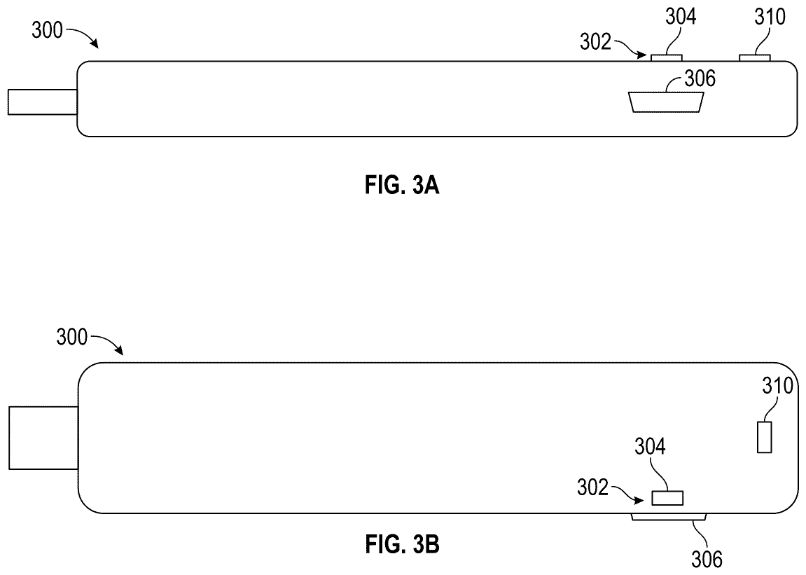

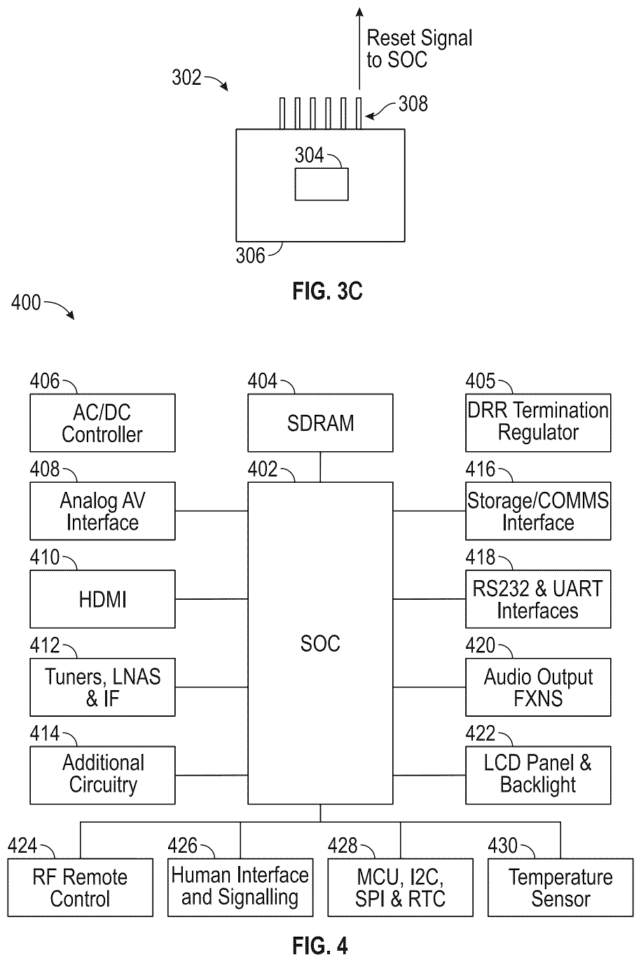

In accordance with features of embodiments described herein, and as illustrated in FIG. 3, an assembly 300 comprising a USB-C port 302 combined with a reset button 304 may be provided for reducing the PCB footprint of the devices when they are individually provided (such as shown in FIGS. 1A, 1B, and 2). In particular embodiments, an additional pin ______ may be provided on the USB-C port 302 to carry a reset signal from the reset button 304 to an SOC of the streaming stick.

### Example Streaming Device With Combination Reset Button/USB-C Port

FIGS. 3A and 3B respectively illustrate top and side plan views of an example streaming device comprising a portable streaming stick 300 that includes an assembly 302 comprising a combined reset button 304 and USB-C connector assembly 306 according to some embodiments of the disclosure. It will be recognized that, although as illustrated in FIGS. 3A and 3B, reset button 304 is implemented using a tactile (or “tact”) button, any other appropriate type of button, switch, and/or detector, such as a low-profile tact button, a capacitive switch, and/or a photodiode, or combinations thereof may be used to implement reset button 304.

FIG. 3C illustrates a representative top plan view of assembly 302. In particular embodiments, a pin 308 is added to USB-C port 306, which pin is electromechanically connected to reset button 304 such that actuation of reset button by a user generates a reset signal to an SOC of streaming stick 300 via pin 308. Reset button 304 may operate in the same manner as reset button 104, such activating (e.g., pressing and holding) the button for a first predetermined length of time (e.g., 10 seconds) results in a factory reset of the stick 300 and activating the button for a second predetermined length of time longer than the first predetermined length of time (e.g., 20 seconds) places the stick in recovery mode. An LED 310 may be provided on a surface of stick 300 to indicate successful entry into factory reset mode and/or recovery mode (e.g., via a particular light color and/or blinking pattern).

As best illustrated in FIG. 3C, a PCB footprint of assembly 302 is nearly identical to PCB footprint of USB-C port 106, as represented by area 204 (FIG. 2); the addition of pin 308 may result in a slight increase in the width (x-direction as illustrated in FIG. 3C) of footprint, but the overall savings in PCB real estate (basically equivalent to area 202 (FIG. 2)) is significant.

### Example TV With HDMI Loopback Factory Reset and Recovery Mode Capabilities

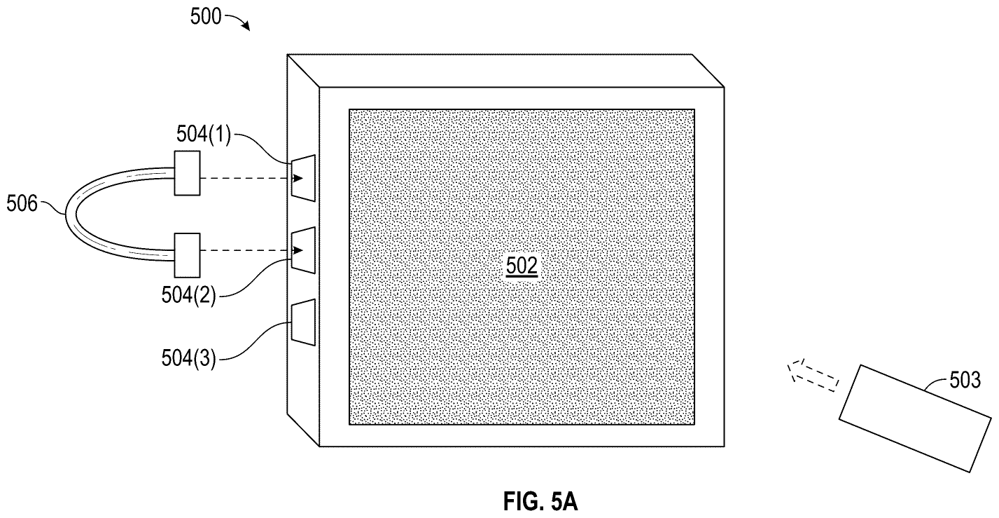

FIG. 4 is a high-level block diagram of an example smart TV system 400 according to some embodiments of the disclosure for implementing HDMI loopback factory reset and recovery mode.

As shown in FIG. 4, in particular embodiments, TV system 400 may include one or more of a system-on-chip (SOC) 402 for controlling operation of TV system 400, synchronous dynamic random access memory (SDRAM) 404, a double data rate (DRR) termination regulator 405, an AC/DC controller 406 for distributing power from mains, an analog AV interface 408, one or more HDMI ports 410, tuners, low noise amplifiers (LNAs), and intermediate frequency (IF) modules 412, and additional circuitry 414. TV system 400 may further include one or more of a storage and communications interfaces 416, RS232 and Universal Asynchronous Receiver Transmitter (UART) interfaces 418, audio output functions 420, an LCD panel and backlight module 422, a radio frequency remote control module 424, a human interface and signaling module 426, a microcontroller unit (MCU), Inter Integrated Circuit protocol (I2C), Serial Peripheral Interface protocol (SPI) and Real Time Communications protocol (RTC) module 428, and a temperature sensor 430.

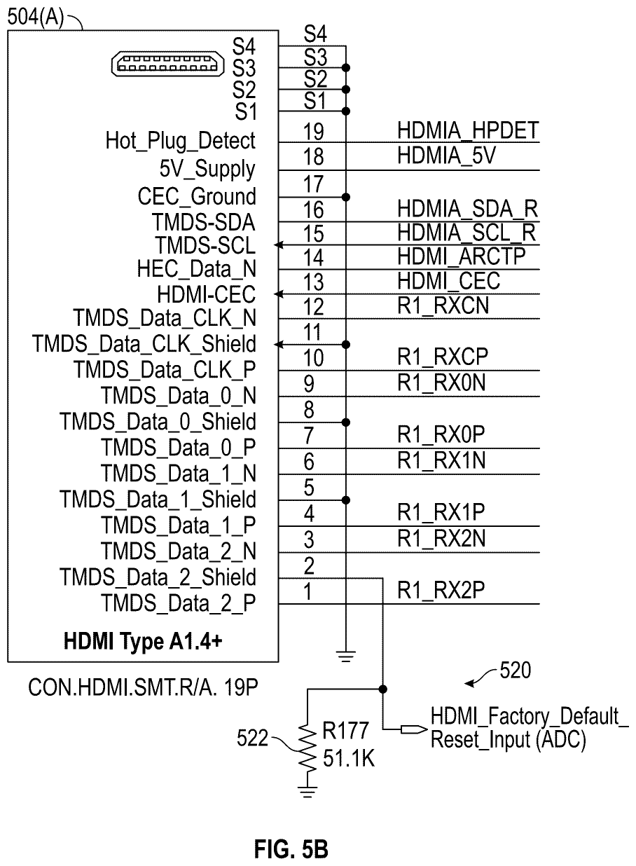

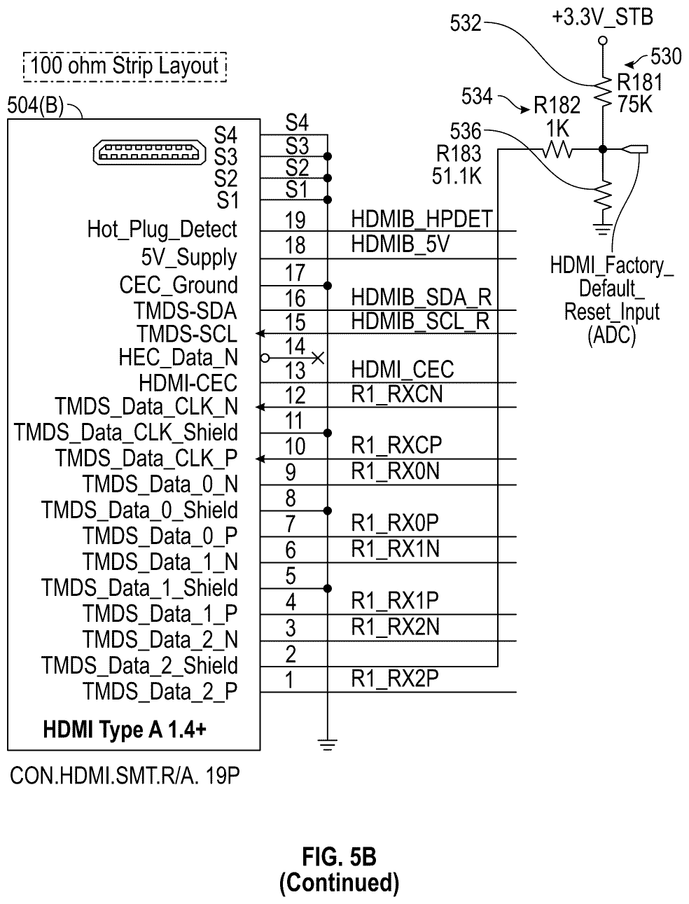

FIG. 5A illustrates connection of an HDMI cable to HDMI ports of a smart TV system 500, which may be implemented in a manner similar or identical to the example smart TV system 400 shown in FIG. 4, according to some embodiments of the disclosure to initiate a factory reset and/or recovery mode of the TV 500 using an HDMI loopback technique according to some embodiments of the disclosure. As shown in FIG. 5A, TV 500 may include an integrated display 502 and may have associated therewith an RF remote controller 503 for interacting with the TV 500 and controlling certain operations thereof. For example, remote controller 503 can cause to be displayed on display 502 a menu and can be used by a user to select an option from the displayed menu.

TV 500 includes three HDMI ports 504(1), 504(2), and 504(3). As shown in FIG. 5A and as will be described in greater detail below, in accordance with features of embodiments described herein, a factory reset of TV 500 may be initiated by inserting one end (or plug) of an HDMI cable 506 (which in particular embodiments is a conventional HDMI cable) into a designated one of HDMI ports 504(1)-504(3), inserting the other end of cable 506 into another designated one of the HDMI ports, and power cycling TV 500 while the cable 506 is thus connected. Such a connection of cable 506 to two HDMI ports of TV 500 may be referred to herein as “HDMI loopback.” It will be recognized that at least two HDMI ports are required for implementing the HDMI loopback device reset technique described herein; however, it will be recognized that embodiments described herein may be implemented in connection with devices that include more than two HDMI ports.

FIG. 5B illustrates example circuitry for enabling an HDMI loopback device reset technique according to some embodiments of the disclosure. Referring to FIG. 5B, circuitry 520 is associated with HDMI port 504(A), which is designated the HDMI factory default reset input port, and includes pin 2 of HDMI port 504(A), which is normally tied to ground. In the illustrated embodiment, pin 2 of HDMI port 504(A), is configured as HDMI_Factory_Default_Reset_Input to an analog to digital converter (ADC) with a pulldown resistor 522 having a value of approximately 50 kiloohms (KΩ); however, it will be recognized that other resistor values may be employed without departing from the spirit or scope of the embodiments proposed herein. It will be further recognized that any ground pin other than pin 2 could be configured as the HDMI_Factory_Default_Reset_Input as described above.

Circuitry 530 is associated with HDMI port 504(B), which is designated the HDMI factory default reset output port, and includes pin 2 of HDMI port 504(B), which is normally tied to ground. Circuitry 530 connects pin 2 of HDMI port 504(B) to a weak voltage divider comprising resistors 532, 534, and 536 (having approximate values of 75 KΩ, 1 KΩ, and 50 KΩ, respectively) that sets the pin to a small voltage level (e.g., approximately 1 volt (V)). In the illustrated embodiment, pin 2 of HDMI port 504(B) is thereby configured as HDMI_Factory_Default_Reset_Output. When an HDMI cable is connected in the manner illustrated in FIG. 5A (i.e., in a loopback configuration), the input HDMI port (HDMI port 504(A)) will detect a voltage on the pin connected to the ADC for purposes of triggering a factory reset (or recovery mode, as described below). It will be recognized that other resistor values may be employed for one or more of resistors 532, 534, and 536 without departing from the spirit or scope of the embodiments proposed herein

It will be recognized that if the other end of an HDMI cable connected to HDMI port 504(A) is connected to an HDMI device (rather than to HDMI port 504(B)), the connection will either ground pin 2 of HDMI port 504(A) due to the HDMI grounds being soldered together, or if the HDMI input is not grounded due to a defect in the cable not connecting the ground pin, then the pull down resistor 522 will pull the pin to ground. Similarly, if the other end of an HDMI cable connected to HDMI port 504(B) is connected to an HDMI device (rather than to HDMI port 504(A)), some current will flow on pin 2 of the HDMI port 504(B). This current could be avoided by driving pin 2 of HDMI port 504(B) to ground via a GPIO, permitting the current to be turned on and off.

It should also be recognized that FIG. 5B illustrates only one example manner in which an HDMI loopback condition may be detected and that other HDMI pins, circuitry, and/or the SOC to which the HDMI devices are connected may be leveraged for signaling and/or detecting an HDMI loopback condition. For example, in one alternative embodiment, cross-wiring of designated data pins on the two HDMI devices (e.g., pins 14 and/or 15) could be detected by the SOC. In operation, during power up, the SOC can check for cross-wiring due to an HDMI loopback condition (e.g., by transmitting data on a designated pin of one of the HDMI devices and monitoring the corresponding pin on the other one of the devices to determine whether the data is received at that pin). If cross-wiring is detected, a factory reset (or recovery mode) is initiated. If cross-wiring is not detected, the SOC can boot the system in a normal manner.

### Example Techniques for Enabling Factory Reset/Recovery Mode Using HDMI Loopback

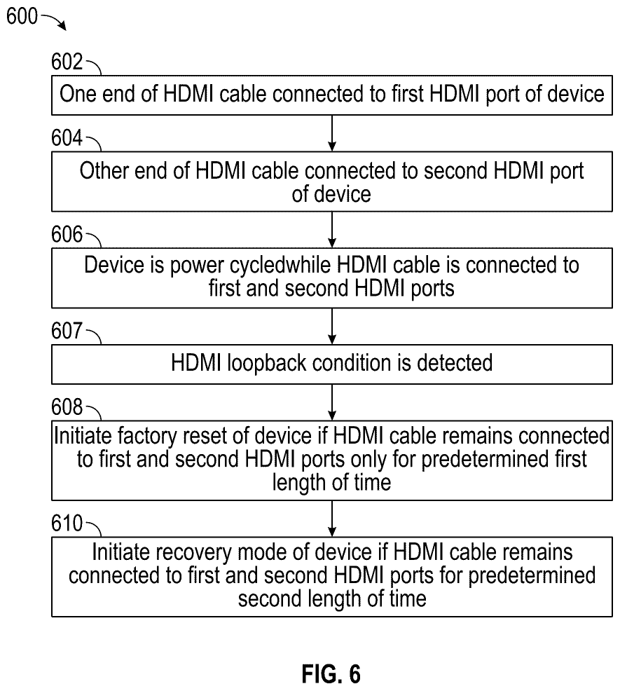

FIG. 6 illustrates a flow chart 600 of example operations for a method of performing an HDMI loopback reset of an electronic media device, such as a TV, according to some embodiments of the disclosure.

In operation 602, one end of an HDMI cable is connected to a first designated HDMI port of the electronic media device.

In operation 604, the other end of the HDMI cable is connected to a second designated HDMI port of the electronic media device.

In operation 606, the device is power cycled (e.g., powered on from an off state or powered off then on from an on state) while the HDMI cable is connected to the first and second designated HDMI ports of the electronic media device.

In operation 607, an HDMI loopback condition is detected. It will be recognized that this operation may be accomplished in a variety of manners, including but not limited to those discussed above with reference to FIG. 5B.

In operation 608, if the HDMI cable remains connected to the first and second designated HDMI ports of the electronic media device for a predetermined first length of time, a factory reset of the electronic media device is initiated. In some embodiments, the predetermined first length of time is approximately 8-10 seconds.

In operation 610, if the HDMI cable remains connected to the first and second designated HDMI ports of the electronic media device for a predetermined second length of time longer than the predetermined first length of time, a recovery mode of the electronic media device is initiated. In some embodiments, the predetermined second length of time is approximately 20 seconds.

In certain embodiments, an LED may be provided on the electronic media device to signal entry into one mode or the other (e.g., by emitting light of particular color or by blinking in a predetermined pattern or at a predetermined rate).

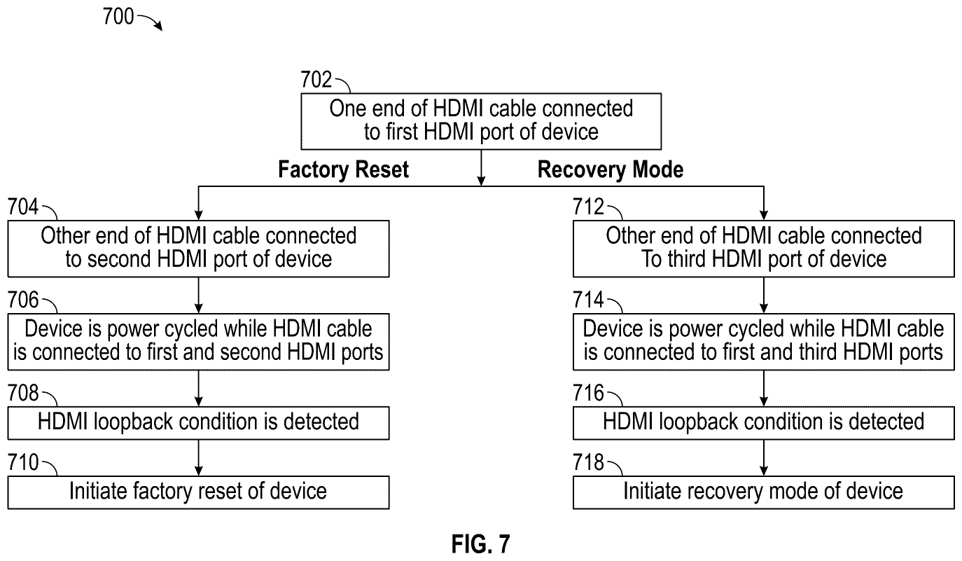

FIG. 7 illustrates a flow chart 700 of example operations for another method of performing a HDMI loopback reset of an electronic media device, such as a TV, according to some embodiments of the disclosure.

In operation 702, one end of an HDMI cable is connected to a first designated HDMI port of the electronic media device. Execution then proceeds along a first path (operations 704-710) for causing a factory reset of the electronic media device or a second path (operations 712-718) for causing the electronic media device to enter a recovery mode.

In operation 704, the other end of the HDMI cable is connected to a second designated HDMI port of the electronic media device.

In operation 706, the electronic media device is power cycled (e.g., powered on from an off state or powered off then on from an on state) while the HDMI cable is connected to the first and second designated HDMI ports of the electronic media device.

In operation 708, an HDMI loopback condition between the first and second HDMI ports is detected. It will be recognized that this operation may be accomplished in a variety of manners, including but not limited to those discussed above with reference to FIG. 5B.

In operation 710, a factory reset of the electronic media device is performed.

In operation 712, the other end of the HDMI cable is connected to a third designated HDMI port of the electronic media device.

In operation 714, the electronic media device is power cycled (e.g., powered on from an off state or powered off then on from an on state) while the HDMI cable is connected to the first and third designated HDMI ports of the electronic media device.

In operation 716, an HDMI loopback condition between the first and third HDMI ports is detected. It will be recognized that this operation may be accomplished in a variety of manners, including but not limited to those discussed above with reference to FIG. 5B.

In operation 718, the electronic media device is caused to enter a recovery mode.

As noted above, in certain embodiments, an LED may be provided on the electronic media device to signal entry into one mode or the other (e.g., by emitting light of particular color or by blinking in a predetermined pattern or at a predetermined rate).

### Example Alternative Embodiments for Enabling Factory Reset/Recovery Mode Without a Dedicated Reset Button

In an alternative embodiment, factory reset and/or recovery mode of an electronic media device may be enabled by including on the device a visible light LED that emits both visible and infrared (IR) light and that transmits a special code when the device is powered on. In this alternative embodiment, a user could position a reflector in front of the LED prior to powering on the device such that reflection of the code back to the device would trigger a factory reset of the device.

In another alternative embodiment, for an electronic media device that includes several input buttons, a user's simultaneously depressing or otherwise actuating a preselected combination of such input buttons during power on of the device would trigger a factory reset of the device.

In yet another alternative embodiment, a reset button could be provided on a remote control for the device. In this alternative embodiment, a user's depressing or otherwise actuating the reset button during power on of the device would trigger a factory reset of the device.

In still another alternative embodiment, a dongle having a USB connector could be provided. In this alternative embodiment, detection of the dongle at a USB port of the device would trigger a factory reset of the device.

In yet another alternative embodiment, a Near Field Communication (NFC) device could be added to an accessible external surface of the electronic media device and a remote controller associated with the device or a smartphone could be used to trigger a factory reset of the device.

### Example Processing Device

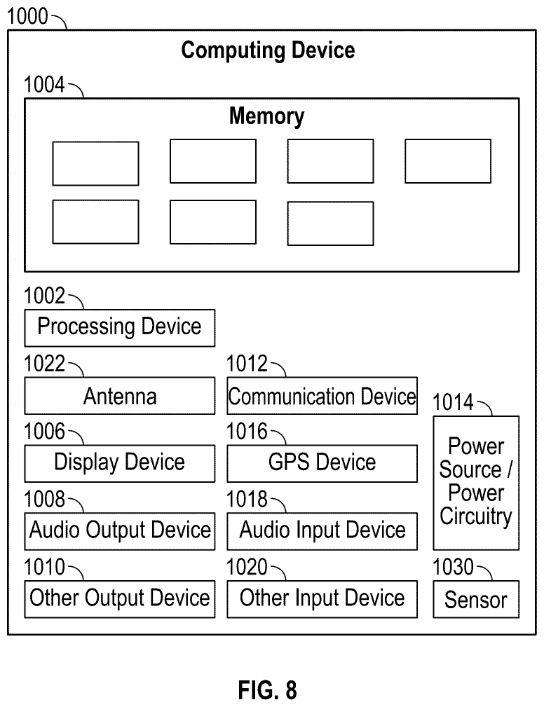

FIG. 8 is a block diagram of an example processing, or computing, device 1000, according to some embodiments of the disclosure. One or more computing devices, such as computing device 1000, may be used to implement the functionalities described with reference to the FIGURES and herein. A number of components are illustrated in the FIGURES as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a SOC die. Additionally, in various embodiments, the computing device 1000 may not include one or more of the components illustrated in FIG. 8, and the computing device 1000 may include interface circuitry for coupling to the one or more components. For example, the computing device 1000 may not include a display device 1006, and may include display device interface circuitry (e.g., a connector and driver circuitry) to which a display device 1006 may be coupled. In another set of examples, the computing device 1000 may not include an audio input device 1018 or an audio output device 1008 and may include audio input or output device interface circuitry (e.g., connectors and supporting circuitry) to which an audio input device 1018 or audio output device 1008 may be coupled.

The computing device 1000 may include a processing device 1002 (e.g., one or more processing devices, one or more of the same type of processing device, one or more of different types of processing device). The processing device 1002 may include electronic circuitry that process electronic data from data storage elements (e.g., registers, memory, resistors, capacitors, quantum bit cells) to transform that electronic data into other electronic data that may be stored in registers and/or memory. Examples of processing device 1002 may include a central processing unit (CPU), a graphical processing unit (GPU), a quantum processor, a machine learning processor, an artificial-intelligence processor, a neural network processor, an artificial intelligence accelerator, an application specific integrated circuit (ASIC), an analog signal processor, an analog computer, a microprocessor, a digital signal processor.

The computing device 1000 may include a memory 1004, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1004 includes one or more non-transitory computer-readable storage media. In some embodiments, memory 1004 may include memory that shares a die with the processing device 1002. In some embodiments, memory 1004 includes one or more non-transitory computer-readable media storing instructions executable to perform operations described with the FIGURES and herein, such as the methods illustrated in FIGS. 3-6. Exemplary parts or modules that may be encoded as instructions and stored in memory 1004 are depicted. Memory 1004 may store instructions that encode one or more exemplary parts. The instructions stored in the one or more non-transitory computer-readable media may be executed by processing device 1002. In some embodiments, memory 1004 may store data, e.g., data structures, binary data, bits, metadata, files, blobs, etc., as described with the FIGURES and herein. Exemplary data that may be stored in memory 1004 are depicted. Memory 1004 may store one or more data as depicted.

In some embodiments, the computing device 1000 may include a communication device 1012 (e.g., one or more communication devices). For example, the communication device 1012 may be configured for managing wired and/or wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1012 may operate in accordance with other wireless protocols in other embodiments. The computing device 1000 may include an antenna 1022 to facilitate wireless communications and/or to receive other wireless communications (such as radio frequency transmissions). The computing device 1000 may include receiver circuits and/or transmitter circuits. In some embodiments, the communication device 1012 may manage wired communications, such as electrical, optical, or any other suitable communication protocols (e.g., the Ethernet). As noted above, the communication device 1012 may include multiple communication chips. For instance, a first communication device 1012 may be dedicated to shorter-range wireless communications such as Wi-Fi or Bluetooth, and a second communication device 1012 may be dedicated to longer-range wireless communications such as global positioning system (GPS), EDGE, GPRS, CDMA, WiMAX, LTE, EV-DO, or others. In some embodiments, a first communication device 1012 may be dedicated to wireless communications, and a second communication device 1012 may be dedicated to wired communications.

The computing device 1000 may include power source/power circuitry 1014. The power source/power circuitry 1014 may include one or more energy storage devices (e.g., batteries or capacitors) and/or circuitry for coupling components of the computing device 1000 to an energy source separate from the computing device 1000 (e.g., DC power, AC power, etc.).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include a sensor 1030 (or one or more sensors). The computing device 1000 may include corresponding interface circuitry, as discussed above). Sensor 1030 may sense physical phenomenon and translate the physical phenomenon into electrical signals that can be processed by, e.g., processing device 1002. Examples of sensor 1030 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1000 may include another output device 1010 (or corresponding interface circuitry, as discussed above). Examples of the other output device 1010 may include an audio codec, a video codec, a printer, a wired or wireless transmitter for providing information to other devices, haptic output device, gas output device, vibrational output device, lighting output device, home automation controller, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1000 may be any other electronic device that processes data.

### SELECTED EXAMPLES

Example 1 provides a portable media streaming device including an assembly including a USB-C port; and a switch integrated with the USB-C port, the switch generating a signal when the switch is actuated, the signal for triggering a factory reset of the portable media streaming device.

Example 2 provides the portable media streaming device of example 1, in which the signal is transmitted to a controller of the portable media streaming device via at least one pin of the USB-C port.

Example 3 provides the portable media streaming device of example 2, in which the at least one pin includes an extra pin added to the USB-C port.

Example 4 provides the portable media streaming device of any one of examples 1-3, in which the switch includes a tactile switch.

Example 5 provides the portable media streaming device of any one of examples 1-4, in which the switch includes a capacitive switch.

Example 6 provides the portable media streaming device of any one of examples 1-5, in which the switch includes at least one photodiode.

Example 7 provides the portable media streaming device of any one of examples 1-6, in which electronics for the USB-C port and electronics for the switch are integrated into a unitary device connected to a printed circuit board (PCB) of the portable media streaming device.

Example 8 provides the portable media streaming device of any one of examples 1-7, further including a light emitting diode (LED) for indicating that the factory reset of the portable media streaming device has been triggered.

Example 9 provides an electronic device including a control system; a first HDMI port including a first plurality of pins, the first HDMI port connected to the control system; a second HDMI port including a second plurality of pins, the second HDMI port connected to the control system; in which one or more of the control system, the first HDMI port, and the second HDMI port are configured to detect a simultaneous connection of a first end of an HDMI cable to the first HDMI port and a second end of the HDMI cable to the second HDMI port and to trigger the control system to cause the electronic device to enter a selected mode based on the detecting.

Example 10 provides the electronic device of example 9, in which the selected mode includes a factory reset mode.

Example 11 provides the electronic device of example 9 or 10, in which the selected mode includes a recovery mode.

Example 12 provides the electronic device of any one of examples 9-11, in which the control system includes a system on chip (SOC).

Example 13 provides the electronic device of example 12, in which the SOC is configured to transmit a data signal on a designated one of the first plurality of pins and monitors a corresponding one of the second plurality of pins.

Example 14 provides the electronic device of any one of examples 9-13, further including circuitry associated with the first and second HDMI ports for enabling the first HDMI port to detect a voltage on a designated pin of the first HDMI port, in which the voltage is generated at a corresponding pin of the second HDMI port.

Example 15 provides the electronic device of any one of examples 9-14, in which the detection is triggered by a power cycle of the electronic device.

Example 16 provides the electronic device of any one of examples 9-15, further including a third HDMI port including a third plurality of pins, the third HDMI port connected to the control system, in which one or more of the control system, the first HDMI port, and the third HDMI port are configured to detect a simultaneous connection of the first end of the HDMI cable to the first HDMI port and the second end of the HDMI cable to the third HDMI port and to trigger the control system to cause the electronic device to enter a recovery mode based on the detection.

Example 17 provides a method of triggering an electronic device to enter one a special mode, the method including detecting that first and second HDMI ports of the electronic device are connected to each other via an HDMI cable; subsequent to a determination that the first and second HDMI ports have been connected to each other for more than a first length of time and less than a second length of time, triggering the electronic device to perform a factory reset.

Example 18 provides the method of example 17, further including subsequent to a determination that the first and second HDMI ports have been connected to each other for more than the second length of time, triggering the electronic device to enter a recovery mode.

Example 19 provides the method of example 17 or 18, in which the detecting is performed by one of the first and second HDMI ports.

Example 20 provides the method of any one of examples 17-19, in which the detecting is performed by a system controller of the electronic device, the first and second HDMI devices connected to the system controller.

### Variations and Other Notes

The above paragraphs provide various examples of the embodiments disclosed herein.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the above detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the above detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device that comprises a list of elements is not necessarily limited to only those elements but may include other elements not expressly listed or inherent to such method, process, or device. Also, the term “or” refers to an inclusive “or” and not to an exclusive “or. ” The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. A portable media streaming device comprising:
an assembly comprising:
a USB-C port; and
a switch integrated with the USB-C port, the switch generating a signal when the switch is actuated, the signal for triggering a factory reset of the portable media streaming device.

2. The portable media streaming device of claim 1, wherein the signal is transmitted to a controller of the portable media streaming device via at least one pin of the USB-C port.

3. The portable media streaming device of claim 2, wherein the at least one pin comprises an extra pin added to the USB-C port.

4. The portable media streaming device of claim 1, wherein the switch comprises a tactile switch.

5. The portable media streaming device of claim 1, wherein the switch comprises a capacitive switch.

6. The portable media streaming device of claim 1, wherein the switch comprises at least one photodiode.

7. The portable media streaming device of claim 1, wherein electronics for the USB-C port and electronics for the switch are integrated into a unitary device connected to a printed circuit board (PCB) of the portable media streaming device.

8. The portable media streaming device of claim 1, further comprising a light emitting diode (LED) for indicating that the factory reset of the portable media streaming device has been triggered.

9. An electronic device comprising:
a control system;
a first HDMI port comprising a first plurality of pins, the first HDMI port connected to the control system;
a second HDMI port comprising a second plurality of pins, the second HDMI port connected to the control system;
wherein one or more of the control system, the first HDMI port, and the second HDMI port are configured to detect a simultaneous connection of a first end of an HDMI cable to the first HDMI port and a second end of the HDMI cable to the second HDMI port and to trigger the control system to cause the electronic device to enter a selected mode based on the detecting.

10. The electronic device of claim 9, wherein the selected mode comprises a factory reset mode.

11. The electronic device of claim 9, wherein the selected mode comprises a recovery mode.

12. The electronic device of claim 9, wherein the control system comprises a system on chip (SOC).

13. The electronic device of claim 12, wherein the SOC is configured to transmit a data signal on a designated one of the first plurality of pins and monitors a corresponding one of the second plurality of pins.

14. The electronic device of claim 9, further comprising circuitry associated with the first and second HDMI ports for enabling the first HDMI port to detect a voltage on a designated pin of the first HDMI port, wherein the voltage is generated at a corresponding pin of the second HDMI port.

15. The electronic device of claim 9, wherein the detection is triggered by a power cycle of the electronic device.

16. The electronic device of claim 9, further comprising a third HDMI port comprising a third plurality of pins, the third HDMI port connected to the control system, wherein one or more of the control system, the first HDMI port, and the third HDMI port are configured to detect a simultaneous connection of the first end of the HDMI cable to the first HDMI port and the second end of the HDMI cable to the third HDMI port and to trigger the control system to cause the electronic device to enter a recovery mode based on the detection.

17. A method of triggering an electronic device to enter one a special mode, the method comprising:
detecting that first and second HDMI ports of the electronic device are connected to each other via an HDMI cable;
subsequent to a determination that the first and second HDMI ports have been connected to each other for more than a first length of time and less than a second length of time, triggering the electronic device to perform a factory reset.

18. The method of claim 17, further comprising:
subsequent to a determination that the first and second HDMI ports have been connected to each other for more than the second length of time, triggering the electronic device to enter a recovery mode.

19. The method of claim 17, wherein the detecting is performed by one of the first and second HDMI ports.

20. The method of claim 17, wherein the detecting is performed by a system controller of the electronic device, the first and second HDMI devices connected to the system controller.
